(19) United States
(12) Patent Application Publication
(10) Pub. No.: US 2017/0331592 A1
(43) Pub. Date: Nov. 16, 2017

(54) TRANSMITTING DEVICE AND RECEIVING METHOD

(71) Applicant: FUJITSU LIMITED, Kawasaki-shi (JP)

(72) Inventors: Shuzo Matsushita, Kawasaki (JP); Makoto Shimizu, Oyama (JP); Hiroshi Nishida, Kawasaki (JP)

(73) Assignee: FUJITSU LIMITED, Kawasaki-shi (JP)

(21) Appl. No.: 15/591,431

(22) Filed: May 10, 2017

(30) Foreign Application Priority Data
May 13, 2016 (JP) 2016-097227

(51) Int. Cl. H04L 1/00

(52) U.S. Cl. CPC H04L 1/0072; H04L 1/0041; H04L 1/0045

(57) ABSTRACT

There is provided a transmitting device including a receiver configured to receive a signal including one of a first signal to which a code relating to error correction is assigned and a second signal to which the code is not assigned, a first synchronization processing circuit configured to perform a first synchronization processing of the first signal, a second synchronization processing circuit configured to perform a second synchronization processing of the second signal, and a switch circuit configured to select one of the signal including the first signal and the signal including the second signal, based on results of the first synchronization processing and the second synchronization processing.

### CROSS-REFERENCE TO RELATED APPLICATION

This application is based upon and claims the benefit of priority of the prior Japanese Patent Application No. 2016-097227, filed on May 13, 2016, the entire contents of which are incorporated herein by reference.

### FIELD

The embodiments discussed herein are related to a transmitting device and a receiving method.

### BACKGROUND

According to an increased demand for communication, a high speed transmission method such as 100 Gigabit Ethernet (GbE: registered trademark) has been spreading. For example, various standards such as 100 GBASE-SR10/LR10/ER10/SR4/LR4/ER4/ER4-Lite are defined by the Institute of Electrical and Electronics Engineers, Inc. (IEEE) 802.3ba.

The 100 GbE of each standard has different types of optical interfaces, different types of optical fibers, and different transmission distances so that there are provided optical transceiver modules such as so-called 100 gigabit form-factor pluggable (CFP) according to individual standards. When a communication speed becomes high, the frequency of occurrence of errors increases. Therefore, in the CFP of some standards, an error correcting function is provided by an error correction code (e.g., see Japanese Laid-Open Patent Publication Nos. 2001-024522 and 2007-221676) such as a forward error correction (FEC).

Related technologies are disclosed in, for example, Japanese Laid-Open Patent Publication Nos. 2001-024522 and 2007-221676.

### SUMMARY

According to an aspect of the invention, a transmitting device includes a receiver configured to receive a signal including one of a first signal to which a code relating to error correction is assigned and a second signal to which the code is not assigned, a first synchronization processing circuit configured to perform a first synchronization processing of the first signal, a second synchronization processing circuit configured to perform a second synchronization processing of the second signal, and a switch circuit configured to select one of the signal including the first signal and the signal including the second signal, based on results of the first synchronization processing and the second synchronization processing.

The object and advantages of the disclosure will be realized and attained by means of the elements and combinations particularly pointed out in the claims.

It is to be understood that both the foregoing general description and the following detailed description are exemplary and explanatory and are not restrictive of the disclosure, as claimed.

### BRIEF DESCRIPTION OF DRAWINGS

FIG. 1 is a block diagram illustrating an example of a transmission system;

FIG. 2 is a block diagram illustrating a comparative embodiment of a physical coding sublayer (PCS) functional unit when an FEC is not used;

FIG. 3 is a view illustrating an example of a transmission method when an FEC is not used;

FIG. 4 is a block diagram illustrating an example of a block synchronization processing unit;

FIG. 5 is a flowchart illustrating an example of control of a synchronization state and an asynchronization state;

FIG. 6 is a block diagram illustrating a comparative embodiment of a PCS functional unit when an FEC is used;

FIG. 7 is a view illustrating an example of a code conversion processing;

FIG. 8 is a view illustrating an example of a transmission method when an FEC is used;

FIG. 9 is a view illustrating an example of an identification code included in an alignment marker;

FIG. 10 is a block diagram illustrating an example of an alignment lock/de-skew unit;

FIG. 11 is a flowchart illustrating an example of control of an alignment lock state and an alignment unlock state;

FIG. 12 is a block diagram illustrating a transmitting device according to an exemplary embodiment;

FIG. 13 is a flowchart illustrating an example of an operation of a transmitting device according to an exemplary embodiment;

FIG. 14 is a view illustrating an example of an operation of changing an FEC setting of a transmission system;

FIG. 15 is a view illustrating an example of an operation of changing an FEC setting of a transmission system;

FIG. 16 is a view illustrating an example of an operation of changing an FEC setting of a transmission system;

FIG. 17 is a view illustrating an example of an operation of changing an FEC setting of a transmission system;

FIG. 18 is a block diagram illustrating a transmitting device according to another exemplary embodiment; and

FIG. 19 is a flowchart illustrating an example of an operation of a transmitting device according to another exemplary embodiment.

### DESCRIPTION OF EMBODIMENTS

A CFP of 100 GBASE-ER4-Lite may convert an FEC to be used or not to be used according to a setting. A signal processing method when the FEC is used is different from a signal processing method when the FEC is not used. Therefore, for example, when settings of the FEC do not match between a transmitting side device and a receiving side device due to an artificial error, the receiving side device does not normally receive an Ethernet (registered trademark) frame. Further, the above-mentioned problems may not be limited to the FEC and occurred in another error correction code.

Hereinafter, an exemplary embodiment of a technique for normally receiving a signal regardless of whether the error correction code is used or not will be described with reference to the drawings.

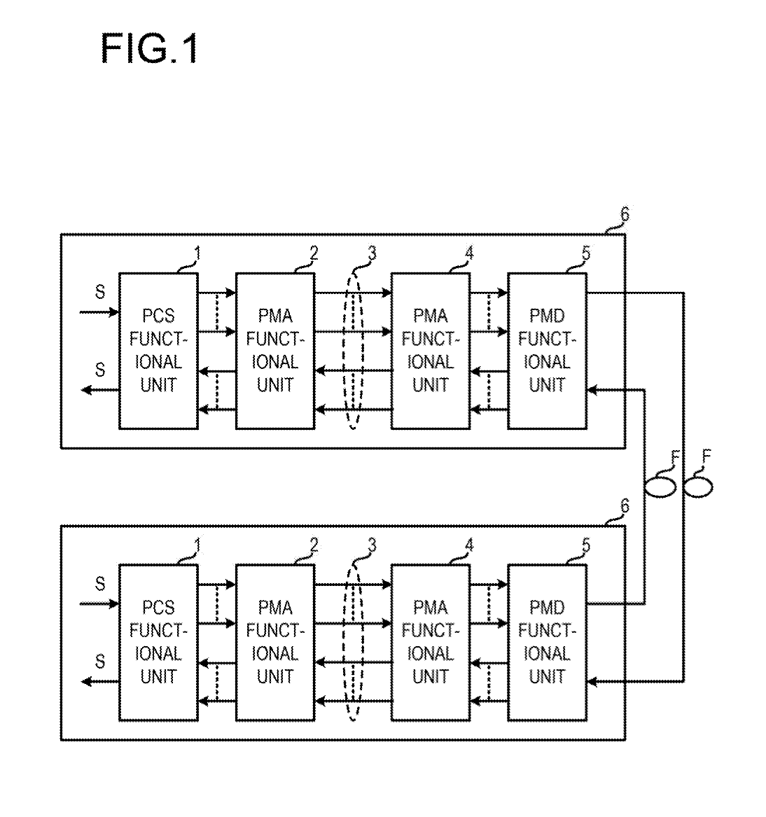

FIG. 1 is a block diagram illustrating an example of a transmission system. The transmission system has one set of transmitting devices 6 which are connected by one pair of optical fibers F. Each transmitting device 6 transmits and receives a signal S in accordance with a transmission scheme defined in, for example, IEEE802.3ba. In this case, a transmission speed between the transmitting devices 6 is, for example, 100 Gbps. Further, the type of signal S is an Ethernet frame, as an example, but is not limited thereto.

Each transmitting device 6 includes a physical coding sublayer (PCS) functional unit 1, physical medium attachment (PMA) functional units 2 and 4, and a physical medium dependent functional unit 5. The PCS functional unit 1 has 20 lines of transmission lanes to divide and transmit the signal S and performs a code conversion processing of the signal S.

The PMA functional unit 2 is connected to the PMA functional unit 4 through a 100 gigabit attachment unit interface (CAUI) 3. The PMA functional unit 2 performs a serial to parallel conversion of the signal S to convert a parallel number of the signal S. More specifically, the PMA functional unit 2 performs the serial to parallel conversion so that a parallel number of the signal S in the PCS functional unit 1 is 20 lines, and a parallel number of the signal S in the CAUI 3 is 10 lines.

The PMD functional unit 5 performs a photoelectric conversion of the signal S to transmit or receive the signal S to or from the other side transmitting device 6 through the optical fiber F. More specifically, the PMD functional unit 5 has, for example, a transmitter that converts the signal S from an electric signal to an optical signal, a multiplexer that multiplexes a wavelength of a predetermined number of optical signals, a splitter that splits the wavelength-multiplexed optical signal for every wavelength, and an optical receiver that converts the signal S from an optical signal to an electric signal. An example of the transmitter is a laser diode and an example of the optical receiver is a photo diode. Further, examples of the multiplexer and the splitter may include a photo coupler and a wavelength selecting switch. Here, the PMD functional unit 5 is an example of a receiver that receives the signal S.

The PMD functional unit 5 multiplexes a wavelength of the optical signal with the number of wavelengths in accordance with the standard to transmit the optical signal. For example, in the case of 100 GBASE-SR10/LR10/ER10, the PMD functional unit 5 multiplexes wavelengths of ten optical signals. Therefore, the PMA functional unit 4 performs transmission processing so that the parallel number of signal S is ten lines in the PMD functional unit 5, and the parallel number is ten lines in the CAUI 3. In this case, a transmission speed of one optical signal is 10 Gbps.

In the case of the 100 GBASE-SR4/LR4/ER4/ER4-Lite, the PMD functional unit 5 multiplexes wavelengths of four optical signals. Therefore, the PMA functional unit 4 performs serial to parallel conversion so that the parallel number of signal S is four lines in the PMD functional unit 5 and the parallel number is ten lines in the CAUI 3. In this case, a transmission speed of one optical signal is 25 Gbps.

The PCS functional unit 1, the PMA functional units 2 and 4, and the PMD functional unit 5 are configured, for example, by optical components or electric circuits. The PMA functional unit 4 and the PMD functional unit 5 may be, for example, installed in the CFP and in this case, is connected to the PMA functional unit 2 through an electrical connector corresponding to the CAUI 3.

Each transmitting device 6 has an FEC setting to select whether to use the FEC for a signal S of transmitting side and a signal S of receiving side. When the FEC setting of the transmitting side is ON, the PCS functional unit 1 transmits the signal by assigning the FEC thereto and when the FEC setting of the transmitting side is OFF, the PCS functional unit 1 transmits the signal S without assigning the FEC thereto. Further, the FEC setting of the receiving side is automatically switched according to the received signal S, which will be described below. Further, in the exemplary embodiment, the FEC is provided as an example of the error correction code, but another error correction code may also be used. The signal S of transmission side is received by the PCS functional unit 1 and transmitted to the optical fiber F by the PMD functional unit 5, and the signal S of receiving side is received from the optical fiber F by the PMD functional unit 5 and transmitted by the PCS functional unit 1.

The configuration of the PCS functional unit 1 when the FEC is used and the FEC is not used will be described below with reference to a comparative embodiment.

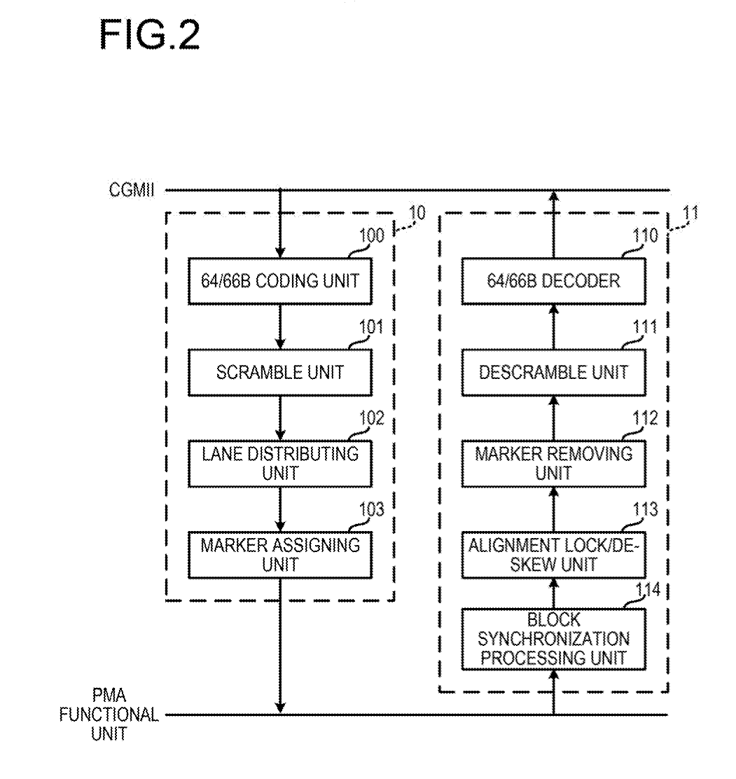

FIG. 2 is a block diagram illustrating a comparative embodiment of the PCS functional unit 1 when the FEC is not used. The PCS functional unit 1 has a transmission processing unit 10 that performs a transmission processing on the signal S and a reception processing unit 11 that performs a reception processing on the signal S.

The transmission processing unit 10 includes a 64/66B coding unit 100, a scramble unit 101, a lane distributing unit 102, and a marker assigning unit 103. The 64/66B coding unit 100 converts the signal S input from 100 gigabit media independent interface (CGMII) into codes of 64/66B blocks. The scramble unit 101 scrambles data in the 64/66B blocks.

The lane distributing unit 102 distributes the scrambled 64/66B blocks into 20 lines of transmission lanes. The lane distributing unit 102 outputs the 64/66B blocks to 20 lines of transmission lanes, for example, in a predetermined order.

The marker assigning unit 103 assigns an alignment marker to the 64/66B blocks for every transmission lane at a constant interval. An identification code for identifying the transmission lane of the 64/66B blocks is included in the alignment marker. The alignment marker and the 64/66B blocks are output to the PMA functional unit 2.

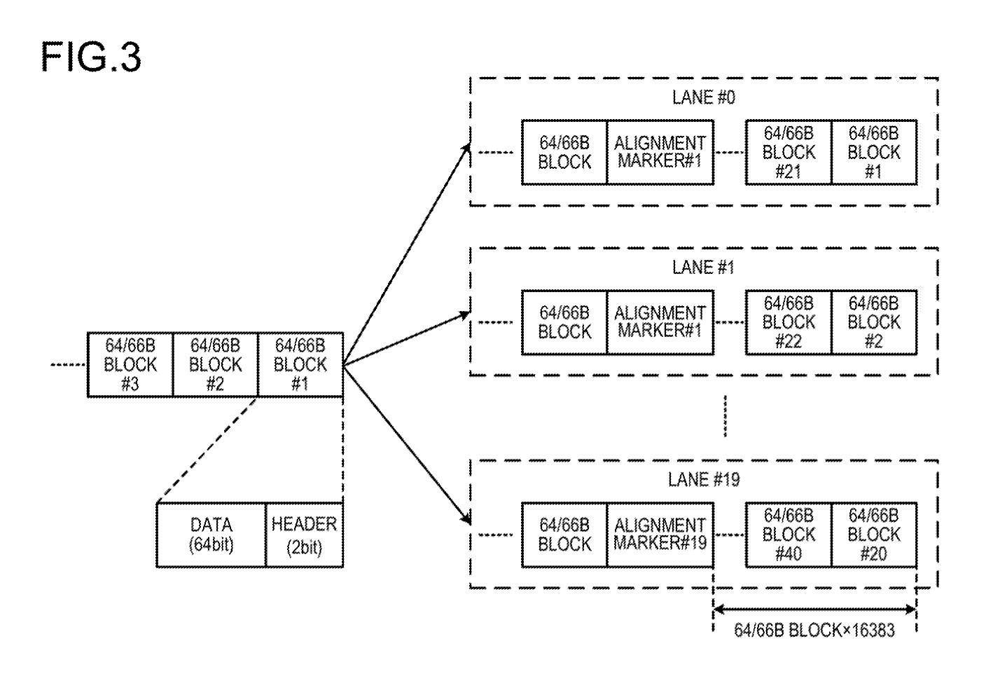

FIG. 3 is a view illustrating an example of a transmission method when an FEC is not used. In the 64/66B blocks, 2 bits of header and 64 bits of data are included to perform a synchronization processing for every block.

The 64/66B blocks #1, #2, . . . are uniformly distributed to each transmission lane #0 to #19 by the lane distributing unit 102. Further, the marker aligning unit 103 inserts one alignment marker #1 to #20 into each of 16383 64/66B blocks with respect to each of the transmission lanes #0 to #19.

Referring to FIG. 2 again, the reception processing unit 11 includes a 64/66B decoder 110, a descramble unit 111, a marker removing unit 112, an alignment lock/de-skew unit 113, and a block synchronization processing unit 114. The block synchronization processing unit 114 performs the block synchronization by a header of the 64/66B block input from the PMA functional unit 2.

The alignment lock de-skew unit 113 performs the synchronization of the alignment marker for every transmission lane #0 to #19 based on the identification code of the alignment marker and adjusts a skew between the transmission lanes #0 to #19. The marker removing unit 112 detects the alignment marker to remove the alignment marker. The descramble unit 111 descrambles the scramble processing of the 64/66B block. The 64/66B decoder 110 converts the code of the descrambled 64/66B block into the original signal S. The signal S obtained by the code conversion is output to the CGMII.

As described above, when the FEC is not assigned to the signal S, the synchronization of the 64/66B block is performed by the block synchronization processing unit 114 after receiving the signal S.

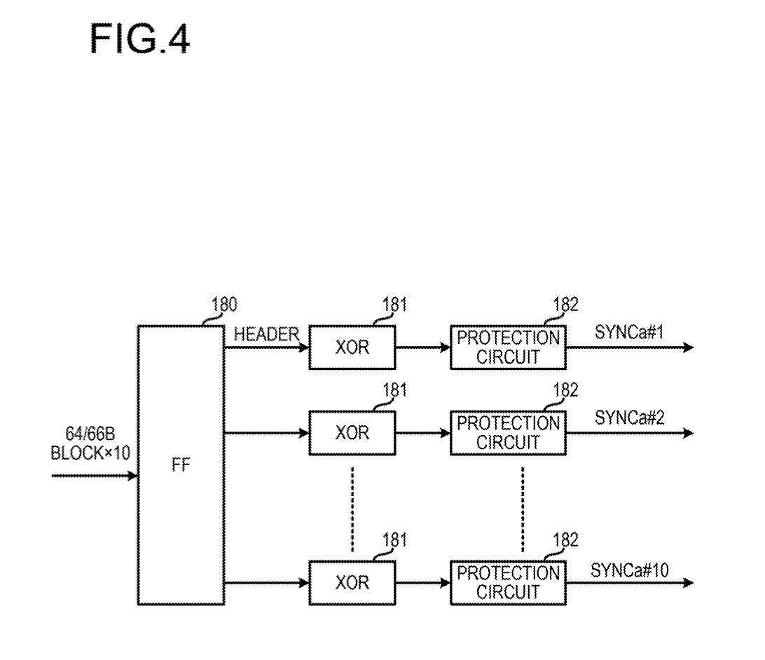

FIG. 4 is a block diagram illustrating an example of the block synchronization processing unit 114. The block synchronization processing unit 114 includes a flip flop (FF) circuit 180, a plurality of XOR circuits 181, and a plurality of protection circuits 182.

In the FF circuit 180, the 64/66B blocks are input in the unit of ten blocks. The FF circuit 180 maintains the 2 bit header which is located at a head of each of the 64/66B blocks and outputs the header to the plurality of XOR circuits 181 while inputting a predetermined trigger signal. The XOR circuit 181 calculates a 2 bit exclusive logical sum of the header to output an operation result to the protection circuit 182.

The header is “01” or “02” (binary) when it is normal. Therefore, when the header is normal, the XOR circuit 181 outputs “1” (binary) and when the header is not normal, the XOR circuit 181 outputs “0” (binary).

The protection circuit 182 performs a protection processing of synchronous detection of the 64/66B block. More specifically, the protection circuit 182 controls the synchronization state and the asynchronization state of the 64/66B block based on the operation value of the XOR circuit 181 and when the state is the synchronization state, outputs a synchronizing signal SYNCa #1 to #10.

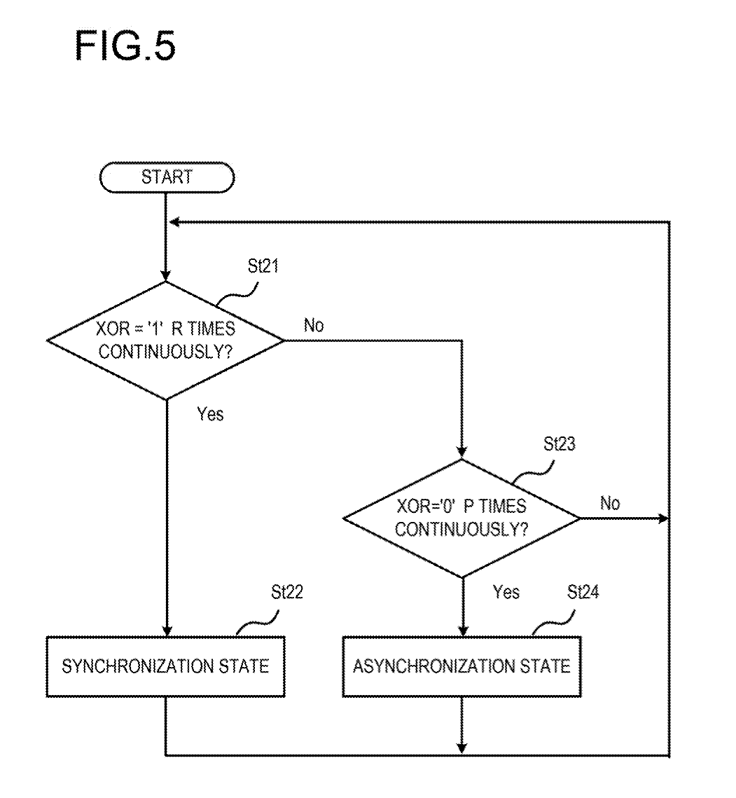

FIG. 5 is a flowchart illustrating an example of control of a synchronization state and an asynchronization state. When the operation value of the XOR circuit 181 is “1” r-times continuously (r is an integer of 2 or larger) (Yes in an operation St21), the protection circuit 182 becomes the synchronization state (operation St22). Thereafter, the protection circuit 182 performs the processing of the operation St21 again.

When the operation value of the XOR circuit 181 is not “1” r-times continuously (No in an operation St21) and the operation value of the XOR circuit 181 is “0” p-times continuously (p is an integer of 2 or larger) (Yes in an operation St23), the protection circuit 182 becomes the asynchronization state (operation St24). Thereafter, the protection circuit 182 performs the processing of the operation St21 again.

When the operation value of the XOR circuit 181 is not “0” p-times continuously (p is an integer of 2 or larger) (No in an operation St23), the protection circuit 182 performs the processing of the operation St21 again. By doing this, the control of the synchronization state and the asynchronization state may be performed.

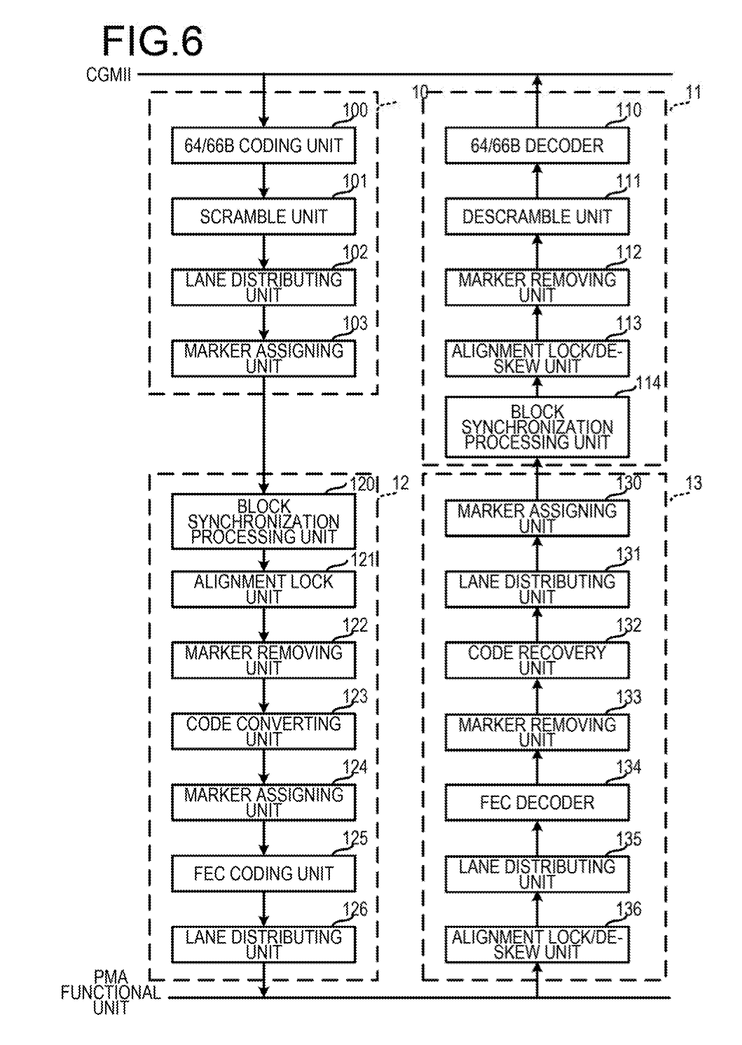

FIG. 6 is a block diagram illustrating a comparative embodiment of the PCS functional unit 1 when the FEC is used. In FIG. 6, a configuration which is common to that in FIG. 2 will be denoted by the same reference numeral and a description thereof will be omitted.

The PCS functional unit 1 includes a transmission processing unit 10, a transmission conversion processing unit 12, a reception processing unit 11, and a reception conversion processing unit 13. That is, the PCS functional unit 1 of the exemplary embodiment is obtained by adding the transmission conversion processing unit 12 and the reception conversion processing unit 13 to the configuration of the PCS functional unit 1 of FIG. 2. The transmission processing unit 10 and the transmission conversion processing unit 12 are connected in series to each other and the reception processing unit 11 and the reception conversion processing unit 13 are connected in series to each other.

The transmission conversion processing unit 12 includes a block synchronization processing unit 120, an alignment lock unit 121, a marker removing unit 122, a code converting unit 123, a marker assigning unit 124, an FEC coding unit 125, and a lane distributing unit 126. The block synchronization processing unit 120 performs a block synchronization by the header of the 64/66B block input from the transmission processing unit 10. In the meantime, units for block synchronization are similar to the block synchronization processing unit 114 of the reception processing unit 11.

The alignment lock unit 121 performs the synchronization for every transmission lane #0 to #19 based on the identification code of the alignment marker. The marker removing unit 122 detects the alignment marker to remove the alignment marker. The code converting unit 123 converts the 64/66B block into a 257B block.

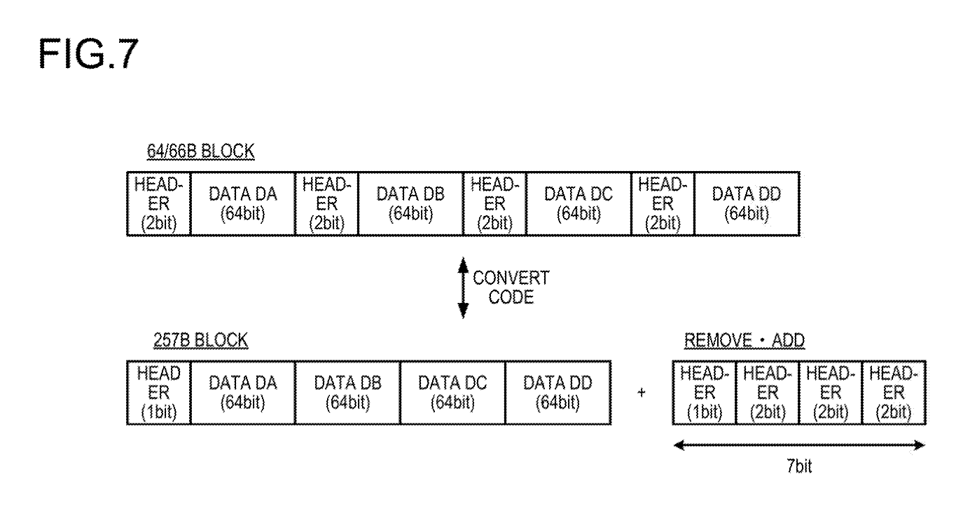

FIG. 7 is a diagram illustrating an example of a code conversion processing. The 257B block includes each data DA to DB of four 64/66B blocks and a one-bit header. That is, when the 64/66B block is converted into the 257B block, 7 bits are removed among the headers of four 64/66B blocks so that the one-bit header and the data DA to DB are accommodated in the 257B block.

Referring back to FIG. 6 again, the marker assigning unit 124 assigns an alignment marker to the 64/66B block for every transmission lane at a constant interval. The FEC coding unit 125 calculates the FEC of the 257B block to assign the FEC to the 257B block. The lane distributing unit 102 distributes the 257B block to which the FEC is assigned into 20 lines of transmission lanes. The 257B block is output to the PMA functional unit 2.

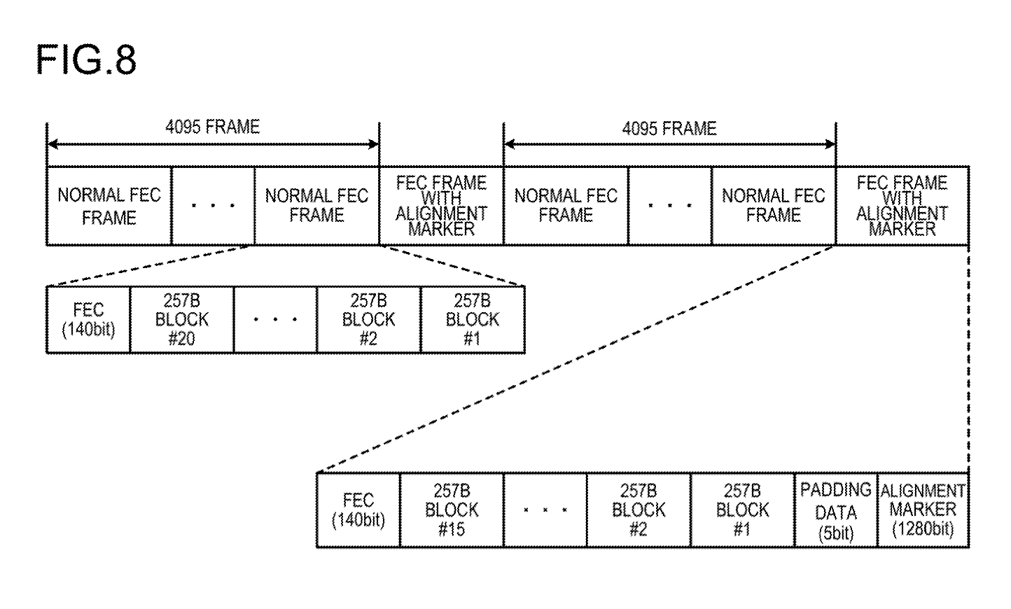

FIG. 8 is a view illustrating an example of a transmission method when the FEC is used. The 257B block and the FEC are accommodated in an FEC frame and transmitted. The FEC frame includes an FEC frame to which an alignment marker is assigned (see “FEC frame with an alignment marker”) and an FEC frame to which an alignment marker is not assigned (see “normal FEC frame”).

The FEC frame with an alignment marker is inserted into each of 4095 FEC frames. The FEC frame with an alignment marker includes 1280 bits alignment marker, 5 bits padding data, 15 257B blocks, and 140 bit FEC. In the meantime, the normal FEC frame includes 20 257B blocks and 140 bits FEC. In this case, a data length of the FEC frame with the alignment marker and the normal FEC frame corresponds to that of 80 64/66B blocks.

Referring back to FIG. 6 again, the reception conversion processing unit 13 includes an alignment lock/de-skew unit 136, a lane distributing unit 135, an FEC decoder 134, a marker removing unit 133, a code recovery unit 132, a lane distributing unit 131, and a marker assigning unit 130. The alignment lock/de-skew unit 136 performs the synchronization of the alignment marker for every transmission lane #0 to #19 based on the identification code of the alignment marker and adjusts a skew between the transmission lanes #0 to #19.

The lane distributing unit 135 distributes the skew-adjusted FEC frame to 20 lines of transmission lanes. The FEC decoder 134 decodes the FEC to correct a data error of the FEC frame. The marker removing unit 133 detects the alignment marker to remove the alignment marker. The code recovery unit 132 recovers the 257B block in the FEC frame to the 64/66B block. In this case, the conversion between the 257B block and the 64/66B block is the same as the description with reference to FIG. 7.

The lane distributing unit 131 distributes the 64/66B blocks to 20 lines of transmission lanes. The marker assigning unit 130 assigns an alignment marker to the 64/66B block for every transmission lane at a constant interval. The 64/66B block to which the alignment marker is assigned is output to the block synchronization processing unit 114 of the reception processing unit 11.

As described above, when the FEC is assigned to the signal S, the synchronization of the alignment marker is performed by the alignment lock/de-skew unit 136 after receiving the signal S. Different identification codes for every transmission lanes #0 to #19 are included in the alignment marker.

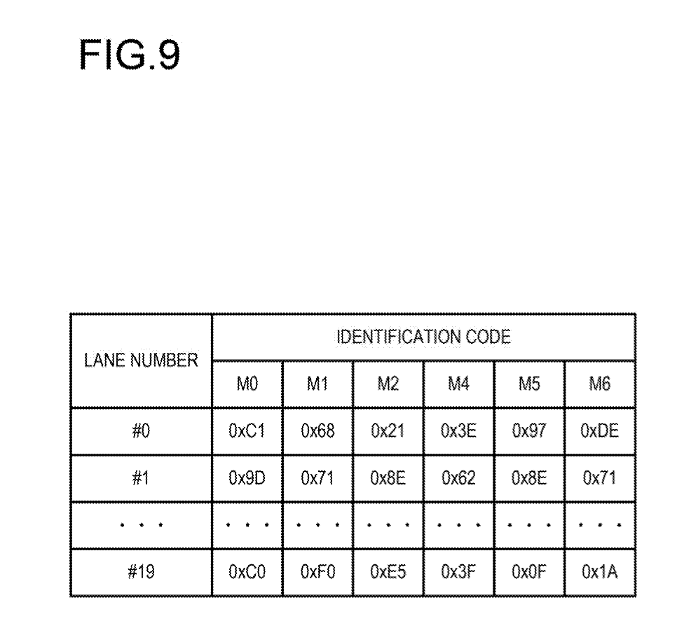

FIG. 9 is a view illustrating an example of an identification code included in an alignment marker. In FIG. 9, “0x” represents a hexadecimal notation.

The alignment marker includes identification codes M0 to M2 and M4 to M6. Values of the identification codes M0 to M2 and M4 to M6 are different from each other for every transmission lane #0 to #19. Therefore, patterns of the identification codes M0 to M2 and M4 to M6 are detected so that the lane numbers #0 to #19 may be identified. Further, the alignment marker includes a bit interleaved parity (BIP) for detecting a bit error in addition to the identification codes M0 to M2 and M4 to M6.

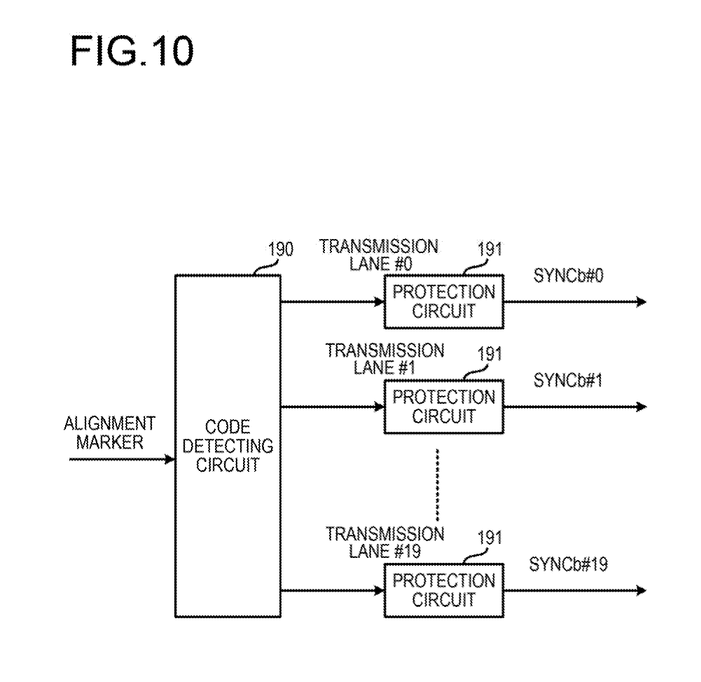

FIG. 10 is a block diagram illustrating an example of the alignment lock/de-skew unit 136. More specifically, in FIG. 10, the configuration for performing the synchronization processing in the alignment lock/de-skew unit 136 is illustrated.

The alignment lock/de-skew unit 136 includes a code detecting circuit 190 and a plurality of protection circuits 191. The protection circuits 191 are provided for every transmission lane #0 to #19. The code detecting circuit 190 detects the pattern of the identification code from the alignment marker to notify detection to the transmission lanes #0 to #19 in accordance with the pattern of the detection.

The protection circuit 191 performs a protection processing of synchronization detection of the alignment marker. More specifically, the protection circuit 191 controls an alignment lock state and an alignment unlock state and in the case of the alignment lock, outputs the synchronizing signals SYNCb #0 to #19.

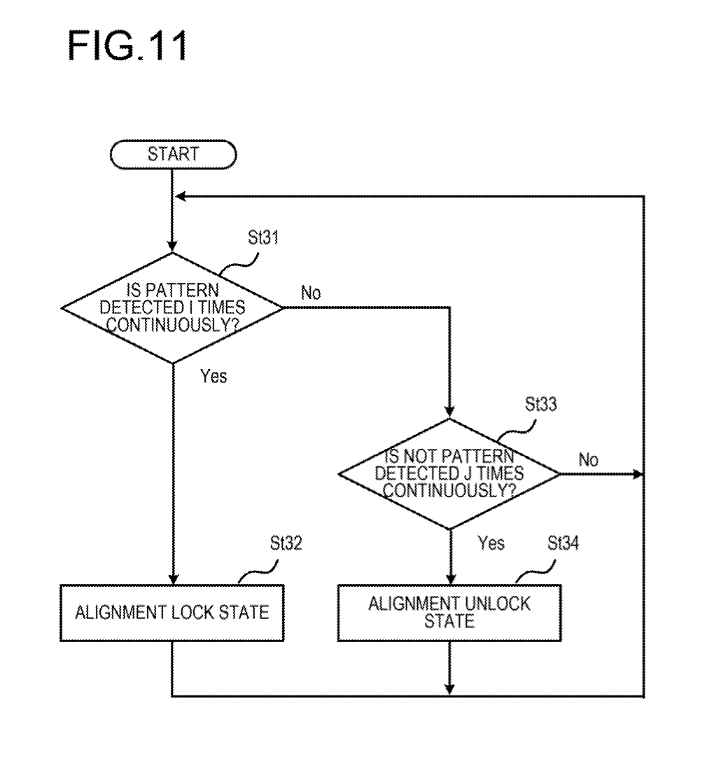

FIG. 11 is a flowchart illustrating an example of control of an alignment lock state and an alignment unlock state. When it is determined that the pattern of the identification codes M0 to M2 and M4 to M6 of the corresponding transmission lanes #0 to #19 is detected i times continuously (i is an integer of 2 or larger) (“Yes” in operation St31), the protection circuit 191 becomes an alignment lock state (operation St32). Thereafter, the protection circuit 191 performs the processing of the operation St31 again.

When it is determined that the pattern of the identification codes M0 to M2 and M4 to M6 of the corresponding transmission lanes #0 to #19 is not detected i times continuously (“No” in operation St31) and the pattern is not detected j times continuously (j is an integer of 2 or larger) (“Yes” in operation St33), the protection circuit 191 becomes the alignment unlock state (operation St34). Thereafter, the protection circuit 191 performs the processing of the operation St31 again.

When it is determined that the pattern is detected j times continuously (“No” in operation St33), the protection circuit 191 performs the processing of the operation St31 again. By doing this, the alignment lock state and the alignment unlock state are controlled.

As described above, the synchronization processing methods after receiving the signal S are different from each other for the cases when the FEC is used and the FEC is not used. That is, when the FEC is used, the synchronization processing is performed by the alignment lock/de-skew unit 136, and when the FEC is not used, the synchronization processing is performed by the block synchronization processing unit 114.

Therefore, the transmitting device 6 of the exemplary embodiment switches the FEC setting of the receiving side in accordance with the synchronization establishment of the signal S between the block synchronization processing unit 114 and the alignment lock/de-skew unit 136. Therefore, the transmitting device 6 normally receives the signal S regardless of whether the FEC is used or not.

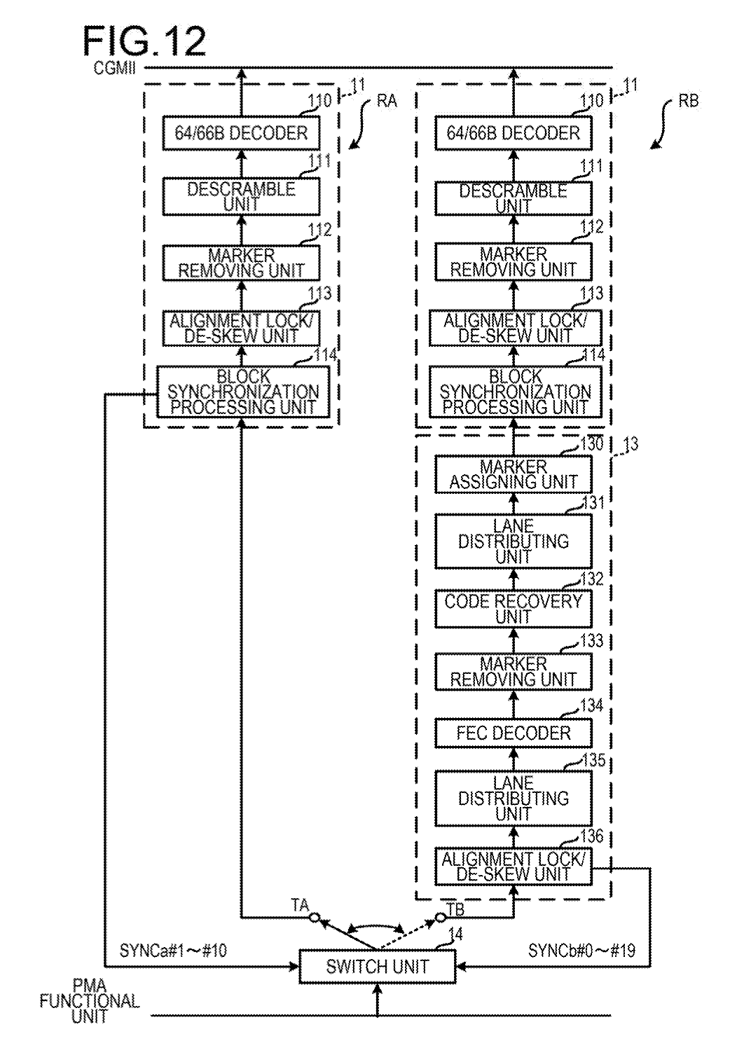

FIG. 12 is a block diagram illustrating a transmitting device 6 according to an exemplary embodiment. In FIG. 12, a configuration which is common to that in FIGS. 2 and 6 will be denoted by the same reference numeral, and a description thereof will be omitted.

More specifically, in FIG. 12, a receiving side circuit configuration of the PCS functional unit 1 is illustrated. The PCS functional unit 1 includes a first reception circuit RA, a second reception circuit RB, and a switch unit 14. The first reception circuit RA includes a reception processing unit 11 and is used when the FEC is not used. The second reception circuit RB includes a reception processing unit 11 and a reception conversion processing unit 13 and is used when the FEC is used. That is, the first reception circuit RA is the receiving side circuit configuration illustrated in FIG. 2 and the second reception circuit RB is the receiving side circuit configuration illustrated in FIG. 6.

The switch unit 14 is a physical switch by which connection of an output destination of the signal S is switched by a predetermined logic. The switch unit 14 switches the output destination of the signal S input from the PMA functional unit 4 between the first reception circuit RA and the second reception circuit RB. More specifically, the switch unit 14 periodically switches the output destination of the signal S between an input terminal TA of the block synchronization processing unit 114 of the first reception circuit RA and an input terminal TB of the alignment lock/de-skew unit 136 of the second reception circuit RB.

As described above, the block synchronization processing unit 114 of the first reception circuit RA establishes the synchronization of a signal S to which the FEC is not assigned, among the received signals S and the alignment lock/de-skew unit 136 of the second reception circuit RB establishes the synchronization of the signal S to which the FEC is assigned, among the received signals S. Here, the alignment lock/de-skew unit 136 is an example of the first synchronization processing unit and the block synchronization processing unit 114 is an example of the second synchronization processing unit.

The switch unit 14 determines one of the block synchronization processing unit 114 and the alignment lock/de-skew unit 136 which establishes the synchronization of the signal S as the output destination of the signal S. Therefore, when the FEC is assigned, the received signal S is output to the second reception circuit RB and when the FEC is not assigned, the received signal S is output to the first reception circuit RA. Here, the switch unit 14 is an example of a controller.

More specifically, when the synchronizing signals SYNCa #1 to #10 are input from the block synchronization processing unit 114, the switch unit 14 fixes the output destination of the signal S to the terminal TA and when the synchronizing signals SYNCb #0 to #19 are input from the alignment lock/de-skew unit 136, fixes the output destination of the signal S to the terminal TB. By doing this, the FEC setting of the receiving side of the transmitting device 6 is automatically switched.

Therefore, the transmitting device 6 normally receives the signal S regardless of whether the FEC is used or not.

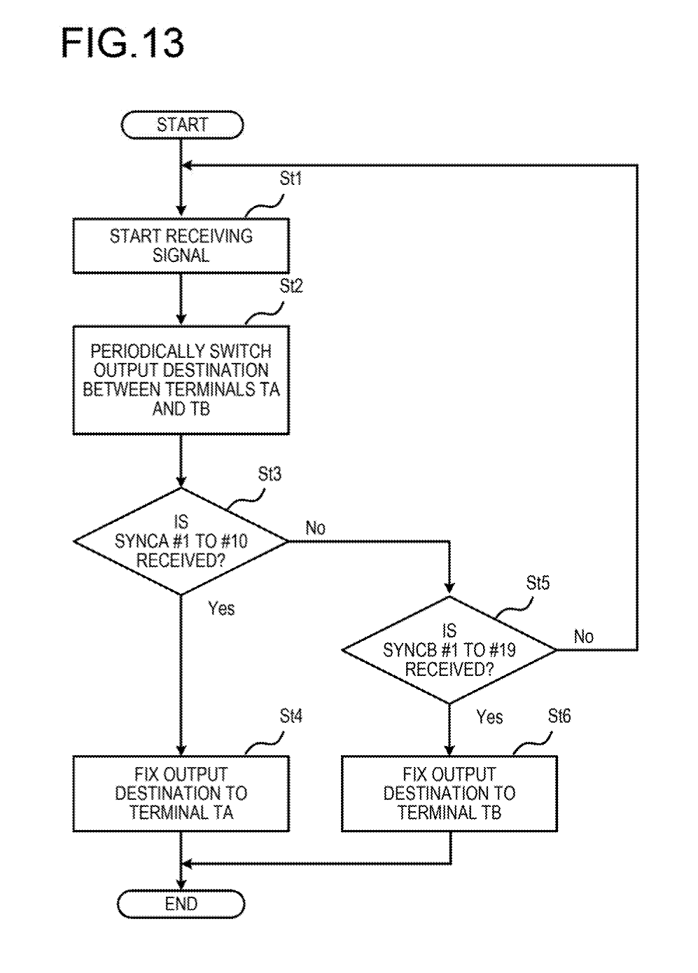

FIG. 13 is a flowchart illustrating an example of an operation of a transmitting device 6 of an exemplary embodiment. First, the PMD functional unit 5 starts receiving a signal S from another transmitting device 6 (operation St1).

Next, the switch unit 14 periodically switches an output destination of a signal S input from the PMD functional unit 5 and the PMA functional unit 4 between terminals TA and TB (operation St2). Therefore, the signal S is alternately output to the block synchronization processing unit 114 of the first reception circuit RA and the alignment lock/de-skew unit 136 of the second reception circuit RB.

Next, the switch unit 14 determines whether to receive the synchronizing signals SYNCa #1 to #10 from the block synchronization processing unit 114 (operation St3). By doing this, the switch unit 14 determines whether the block synchronization processing unit 114 establishes the synchronization.

When it is determined that the switch unit 14 receives the synchronizing signals SYNCa #1 to #10 (“Yes” in operation St3), that is, when the block synchronization processing unit 114 establishes synchronization, the switch unit 14 fixes the output destination of the signal S to the terminal TA (operation St4). Therefore, the first reception circuit RA is determined as the output destination of the signal S. In this case, since the FEC is not assigned to the signal S, the FEC setting of the receiving side is OFF.

When it is determined that the synchronizing signals SYNCa #1 to #10 are not received (“No” in operation St3), the switch unit 14 determines whether the synchronizing signals SYNCb #0 to #19 are received from the alignment lock/de-skew unit 136 (operation St5). By doing this, the switch unit 14 determines whether the alignment lock/de-skew unit 136 establishes the synchronization.

When it is determined that the switch unit 14 receives the synchronizing signals SYNCb #0 to #19 (“Yes” in operation St5), that is, the alignment lock/de-skew unit 136 establishes synchronization, the switch unit 14 fixes the output destination of the signal S to the terminal TB (operation St6). Therefore, the second reception circuit RB is determined as the output destination of the signal S. In this case, since the FEC is assigned to the signal S, the FEC setting of the receiving side is ON.

When it is determined that the synchronizing signals SYNCb #0 to #19 are not received (“No” in operation St5), the switch unit 14 performs the processing of the operation St1 again. In this case, since none of the block synchronization processing unit 114 and the alignment lock/de-skew unit 136 establishes the synchronization, it is considered that an error is incurred in the signal S and there is a retrial to receive the signal S. By doing this, the transmitting device 6 operates.

In the above-described receiving method, the signal S is received and one of the alignment lock/de-skew unit 136 establishing the synchronization of the signal S to which the FEC is assigned and the block synchronization processing unit 114 establishing the synchronization of the signal S to which the FEC is not assigned which establishes the synchronization is determined as the output destination of the received signal S. Therefore, the transmitting device 6 normally receives the signal S, regardless of whether the FEC is used or not.

As described above, the transmitting device 6 switches the FEC setting of the receiving side by the switch unit 14 depending on whether there is an FEC in the received signal S. Therefore, the transmitting device 6 may change the FEC setting of the transmitting side in accordance with the FEC setting of the receiving side.

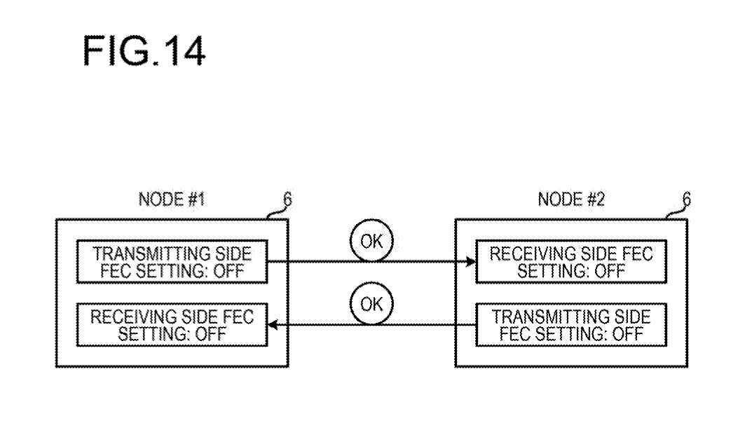

FIGS. 14 to 17 are views illustrating an example of an operation of changing an FEC setting of a transmission system. In the transmission system according to the exemplary embodiment, in one set of opposing transmitting devices 6, one is provided in a node #1 and the other is provided in a node #2.

As illustrated in FIG. 14, in an initial state, a FEC setting of the transmitting side and a FEC setting of the receiving side of the transmitting devices 6 are off (see “OFF”). Therefore, the signal S is normally transmitted and received in any one of a transmitting direction from a node #1 to a node #2 and a transmitting direction from the node #2 to the node #1 (see “OK”).

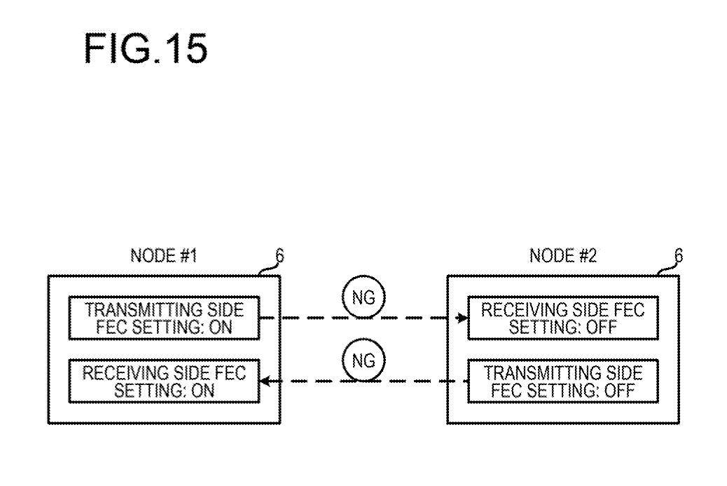

Next, as illustrated in FIG. 15, when the transmitting side and FEC setting of the receiving sides are on (see “ON”) in the transmitting device 6 of the node #1, the signal S is not normally transmitted and received in each transmitting direction (see “NG”).

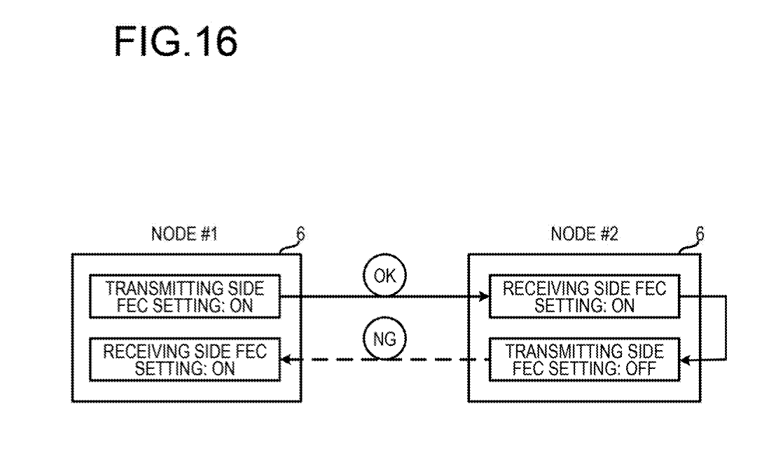

Next, as illustrated in FIG. 16, in the transmitting device 6 in the node #2, the FEC setting of the receiving side is switched to be on by the operation of the switch unit 14. Therefore, the signal S is normally transmitted and received in the transmitting direction from the node #1 to the node #2. In this case, the FEC setting of the receiving side is reflected to the FEC setting of the transmitting side as indicated by the arrow.

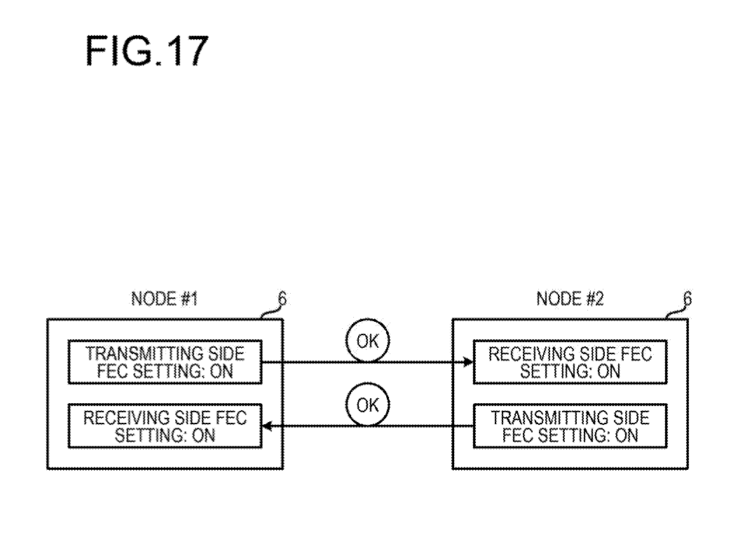

When the FEC setting of the receiving side is reflected to the FEC setting of the transmitting side, as illustrated in FIG. 17, the FEC setting of the transmitting side in the transmitting device 6 in the node #2 is switched to be on. Therefore, the signal S is normally transmitted and received in each transmitting direction.

As described above, even though the FEC setting of another opposing transmitting device 6 is changed, the transmitting device 6 according to the exemplary embodiment may be recovered to a state when the signal S is normally transmitted and received by reflecting the FEC setting of the receiving side to the FEC setting of the transmitting side.

In the configuration of FIG. 12, the reception processing unit 11 is common between the first reception circuit RA and the second reception circuit RB, but the reception processing units are separately provided. Therefore, as it will be described below, in the PCS functional unit 1, a part of the reception processing unit 11 is commonly used so that a circuit size may be reduced.

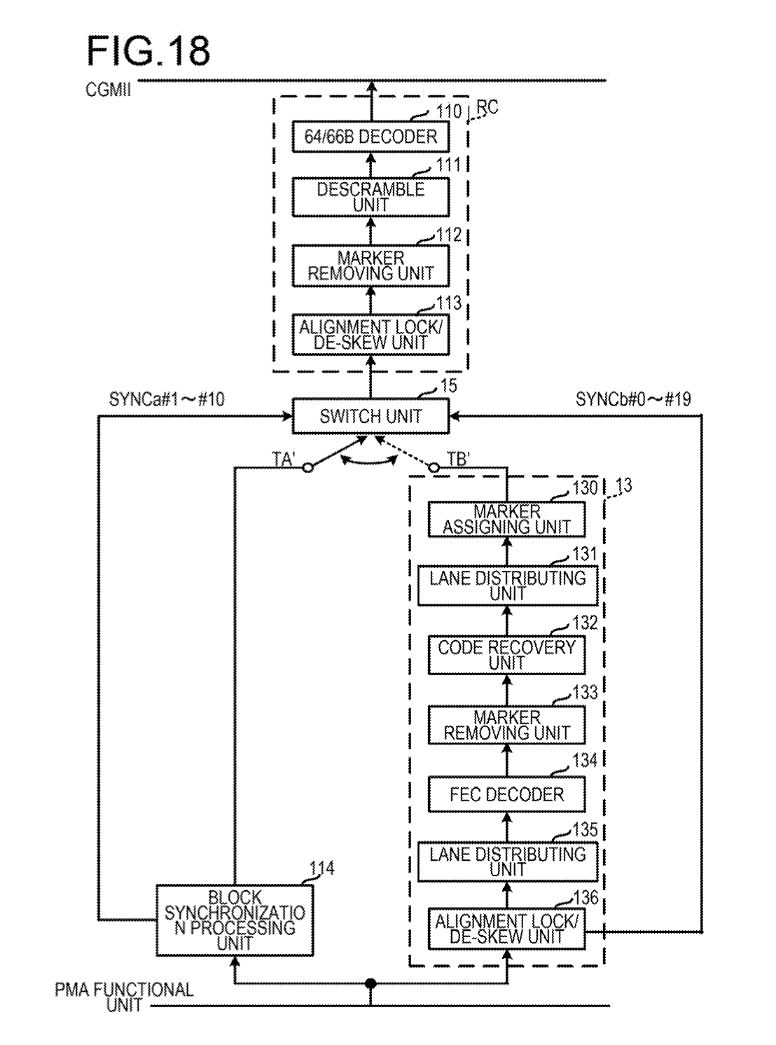

FIG. 18 is a block diagram illustrating a transmitting device 6 according to another exemplary embodiment. In FIG. 18, a configuration which is common to that in FIGS. 2 and 6 will be denoted by the same reference numeral and a description thereof will be omitted.

More specifically, in FIG. 18, a receiving side circuit configuration of the PCS functional unit 1 is illustrated. The PCS functional unit 1 includes a common processing unit RC, a block synchronization processing unit 114, a switch unit 15, and a reception conversion processing unit 13. The common processing unit RC is a part of the configuration of the reception processing unit 11 and includes a 64/66B decoder 110, a descramble unit 111, a marker removing unit 112, and an alignment lock/de-skew unit 113.

The block synchronization processing unit 114 is used when the FEC is not used, and the reception conversion processing unit 13 is used when the FEC is used. Further, the common processing unit RC is used, regardless of whether the FEC is used or not. That is, the common processing unit RC is an example of a signal processor and performs a common signal processing on a signal to which the FEC is assigned and a signal S to which the FEC is not assigned.

The signal S which is input from the PMA functional unit 4 is output to the block synchronization processing unit 114 and the alignment lock/de-skew unit 136 of the reception conversion processing unit 13. When the synchronization of the signal S is established, the block synchronization processing unit 114 outputs the synchronizing signals SYNCa #1 to #10 to the switch unit 15 and when the synchronization of the signal S is established, the alignment lock/de-skew unit 136 outputs the synchronizing signals SYNCb #0 to #19 to the switch unit 15.

The switch unit 14 is a physical switch by which connection of an input source of the signal S is switched by a predetermined logic. The switch unit 15 is another example of the controller and any one of the block synchronization processing unit 114 and the alignment lock/de-skew unit 136 of the reception conversion processing unit 13 which establishes the synchronization is determined as the input source of the signal S to the common processing unit RC.

Therefore, when the FEC is assigned, the received signal S is output from the alignment lock/de-skew unit 136 of the reception conversion processing unit 13 to the common processing unit RC and when the FEC is not assigned, the received signal S is output from the block synchronization processing unit 114 to the common processing unit RC.

More specifically, the switch unit 15 selects any one of an output terminal TA′ of the block synchronization processing unit 114 and an output terminal TB′ of the reception conversion processing unit 13 as the input source of the signal S. When the synchronizing signals SYNCa #1 to #10 are input from the block synchronization processing unit 114, the switch unit 15 fixes the input source of the signal S to the output terminal TA′ and when the synchronizing signals SYNCb #0 to #19 are input from the alignment lock/de-skew unit 136, fixes the input source of the signal S to the output terminal TB′. By doing this, the FEC setting of the receiving side of the transmitting device 6 is automatically switched.

Therefore, the transmitting device 6 normally receives the signal S regardless of whether the FEC is used or not.

The signal S is simultaneously output to the block synchronization processing unit 114 and the alignment lock/de-skew unit 136 of the reception conversion processing unit 13, so that the switch unit 15 may quickly select the input source. In contrast, in the case of the example of FIG. 12, the switch unit 14 alternately outputs the signal S to the block synchronization processing unit 114 and the alignment lock/de-skew unit 136 and then selects the output destination, so that a time for selection is longer than that of the example.

In this example, a part of the reception processing unit 11 is used regardless of whether the FEC is used or not, so that the size of the circuit may be reduced as compared with the example of FIG. 12.

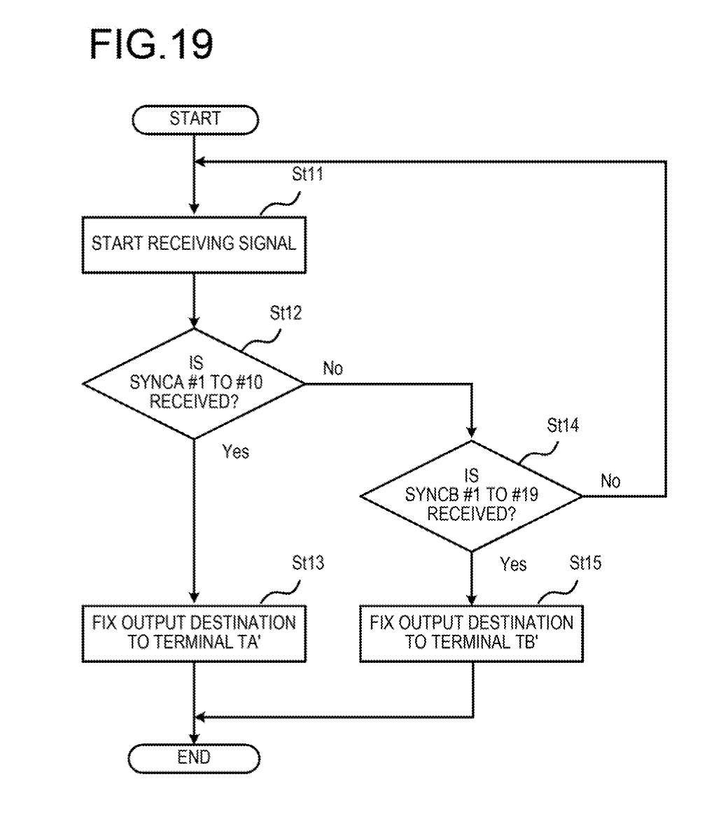

FIG. 19 is a flowchart illustrating an example of an operation of a transmitting device 6 of an exemplary embodiment. First, the PMD functional unit 5 starts receiving a signal S from another transmitting device 6 (operation St11).

Next, the switch unit 15 determines whether to receive the synchronizing signals SYNCa #1 to #10 from the block synchronization processing unit 114 (operation St12). By doing this, the switch unit 15 determines whether the block synchronization processing unit 114 establishes the synchronization.

When it is determined that the switch unit 15 receives the synchronizing signals SYNCa #1 to #10 (“Yes” in operation St12), that is, the block synchronization processing unit 114 establishes synchronization, the switch unit 15 fixes the input source of the signal S to the terminal TA′ (operation St13). Accordingly, the block synchronization processing unit 114 is determined as the input source of the signal S to the common processing unit RC. In this case, since the FEC is not assigned to the signal S, the FEC setting of the receiving side is off.

When it is determined that the synchronizing signals SYNCa #1 to #10 are not received (“No” in operation St12), the switch unit 15 determines whether the synchronizing signals SYNCb #0 to #19 are received from the alignment lock/de-skew unit 136 (operation St14). By doing this, the switch unit 15 determines whether the alignment lock/de-skew unit 136 establishes the synchronization.

When it is determined that the switch unit 15 receives the synchronizing signals SYNCb #0 to #19 (“Yes” in operation St14), that is, the alignment lock/de-skew unit 136 establishes synchronization, the switch unit 15 fixes the input source of the signal S to the terminal TB′ (operation St15). Accordingly, the reception conversion processing unit 13 is determined as the input source of the signal S to the common processing unit RC. In this case, since the FEC is assigned to the signal S, the FEC setting of the receiving side is on.

When it is determined that the synchronizing signals SYNCb #0 to #19 are not received (“No” in operation St14), the switch unit 15 perform the processing of the operation St1 again. In this case, since none of the block synchronization processing unit 114 and the alignment lock/de-skew unit 136 establishes the synchronization, it is considered that an error is incurred in the signal S and there is a retrial to receive the signal S. By doing this, the transmitting device 6 operates.

In the above-described receiving method, the signal S is received and one of the alignment lock/de-skew unit 136 establishing the synchronization of the signal S to which the FEC is assigned and the block synchronization processing unit 114 establishing the synchronization of the signal S to which the FEC is not assigned which establishes the synchronization is determined as the input source of the received signal S to the alignment lock/de-skew unit 113. Therefore, the transmitting device 6 normally receives the signal S regardless of whether the FEC is used or not.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiment(s) of the present disclosure has (have) been described in detail, it should be understood that the various changes, substitutions, and alterations could be made hereto without departing from the spirit and scope of the disclosure.

What is claimed is:

1. A transmitting device comprising:
a receiver configured to receive a signal including one of a first signal to which a code relating to error correction is assigned and a second signal to which the code is not assigned;
a first synchronization processing circuit configured to perform a first synchronization processing of the first signal;
a second synchronization processing circuit configured to perform a second synchronization processing of the second signal; and
a switch circuit configured to select one of the signal including the first signal and the signal including the second signal, based on results of the first synchronization processing and the second synchronization processing.

2. The transmitting device according claim 1,
wherein the switch circuit periodically switches a destination of the signal received by the receiver between the first synchronization processing circuit and the second synchronization processing circuit, and fixes the destination of the signal received by the receiver, based on results of the first synchronization processing and the second synchronization processing during the periodically switching.

3. The transmitting device according claim 1,
wherein the switch circuit selects one of the signal including the first signal performed by the first synchronization processing and the signal including the second signal performed by the second synchronization processing, based on results of the first synchronization processing and the second synchronization processing.

4. A receiving method comprising:
receiving a signal including one of a first signal to which a code relating to error correction is assigned and a second signal to which the code is not assigned; and
selecting one of the signal including the first signal performed by a first synchronization processing of the first signal and the signal including the second signal performed by a second synchronization processing of the second signal, based on results of the first synchronization processing and the second synchronization processing.

5. The receiving method according claim 4,
wherein a destination of the signal received is periodically switched between the first synchronization processing and the second synchronization processing, and the destination of the signal received is fixed, based on results of the first synchronization processing and the second synchronization processing during the periodically switching.

6. The receiving method according claim 4,
wherein one of the signal including the first signal performed by the first synchronization processing and the signal including the second signal performed by the second synchronization processing is selected, based on results of the first synchronization processing and the second synchronization processing.
